(19) United States
(12) Patent Application Publication
(10) Pub. No.: US 2013/0151411 A1
(43) Pub. Date: Jun. 13, 2013

(54) DIGITAL AUTHENTICATION AND SECURITY METHOD AND SYSTEM

(71) Applicant: WORLDPASSKEY, INC., Cranston, RI (US)

(72) Inventor: Mark Carten, Johnston, RI (US)

(73) Assignee: WORLDPASSKEY, INC., Cranston, RI (US)

(21) Appl. No.: 13/707,761

(22) Filed: Dec. 7, 2012

Related U.S. Application Data
(60) Provisional application No. 61/569,025, filed on Dec. 9, 2011.

(51) Int. Cl. G06Q 20/38

(52) U.S. Cl. CPC G06Q 20/3821
USPC 705/44

(57) ABSTRACT

A method and system for activating a user account and digitally securing electronic transactions is disclosed. The method and system includes the steps providing a code and PIN, requesting the PIN, transmitting the PIN and code together to an authentication server, authenticating the code and PIN, flagging a status of a user's account as “on”, transmitting the status of the user's account to a client server, allowing a digital transaction to proceed on the client server if the status of the user's account is “on”, and disallowing a digital transaction to proceed on the client server if the status of the user's account is “off”. Once activated, the user may toggle their account “on” and “off” via a mobile device in order to provide an additional layer of security in order to complete transactions.

### CROSS-REFERENCE TO RELATED APPLICATION

This application claims priority to earlier filed U.S. Provisional Application Ser. No. 61/569,025, filed Dec. 9, 2011, the contents of which are incorporated herein by reference.

### BACKGROUND OF THE INVENTION

1. Field of the Invention

The present invention relates generally to controlling access to services that are provided thorough computerized networks and more particularly a method and system of securely authenticating a user as being entitled to a desired service.

2. Background of the Related Art

Communication security between a customer or user and a website, such as a retailer or bank, is critical in order to prevent fraudulent transactions and identity theft. Traditionally, users are assigned a login and password combination, both of which are necessary to access the website. However, passwords may be compromised and user logins are often an email address of the user. Passwords may also be cracked or guessed using techniques known in the art. Therefore, there is a need in the prior art for identifying a user as an authorized user for a system, even if they have a proper login credentials.

### SUMMARY OF THE INVENTION

A method and system are disclosed for a 2-factor approach of user authentication for accessing services over a network, such as the Internet. The computer based method and system includes accepting a token associated with a device and accepting a personal identifier. The method and system applies a validation test on the token and the personal identifier to determine whether they are a matching pair. In case of having passed the validation test, the system authorizes a service requested by a user.

A method and system is also disclosed for a user to access a computerized network provided service. The method includes sending through a network a token from a device, which token is uniquely associated with the device. The method further includes sending over the network a personal identifier of the user.

The disclosed system and method includes devices capable of sending tokens through USB ports of processors, and includes mobile devices capable of sending tokens over propagating signals.

### BRIEF DESCRIPTION OF THE DRAWINGS

These and other features, aspects, and advantages of the present invention will become better understood with reference to the following description, appended claims, and accompanying drawings where:

FIG. 1 symbolically shows an embodiment of digital authentication using a USB transmitted token;

FIG. 2 symbolically shows an embodiment of digital authentication using cell phone provided token;

FIG. 3 schematically depicts a top view of a representative embodiment of the present invention;

FIG. 4 symbolically shows use of an embodiment of the present invention over an Internet portal;

FIG. 5 shows a flow chart of an exemplary authentication process for a user;

FIG. 6 shows a flow chart of a user interacting with a secured website, such as a bank;

FIG. 7 shows a flow chart of a user interacting with secured website using a web browser; and

FIG. 8 shows a schematic diagram of the process of activating a bank card or website through a smartphone.

### DESCRIPTION OF THE PREFERRED EMBODIMENT

Embodiments of the present invention provide a fraud prevention system and method. In the following the term WorldPassKey (WPK) shall be used to refer in general to the embodiments of the present invention.

WPK is based on a 2-factor security scheme. This 2-factor approach adds a second level of security that enhances the username and password system commonly used in the art.

The WPK system may incorporate 2 alphanumeric strings. The first factor of the 2-factor approach is an embedded alphanumeric string not seen by the user. The second factor of the 2-factor approach is an alphanumeric string of personal identification number (PIN), appropriately entered by a user.

Embodiments of the present invention may include electronic flash memory data storage devices, such as, without limitation, a USB drive device, for instance, a thumb drive. Embodiment of the present invention may include mobile communication devices, such as, without limitation, cell phones and tablet devices. The data storage devices and mobile communication devices may be used to store an embedded alphanumeric string not seen by the user.

Embodiments of the present invention may also include one or a multitude of internet based authentication and verification servers, and computer software, including internet web page based code, and methods of application for providing the user with an internet based point of purchase service which provides authentication and verification of a user and, and for instance, user payment information during the process of purchasing products or services from internet based websites.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as “logic”, or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

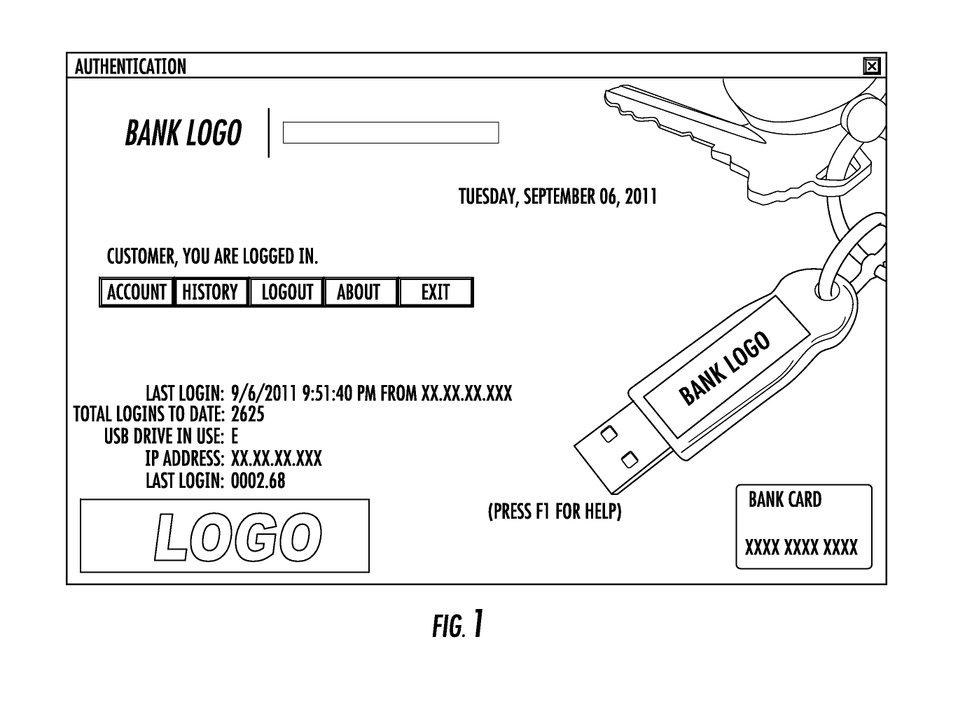

FIG. 1 symbolically shows an embodiment of digital authentication using a USB transmitted token, when the first factor, the embedded alphanumeric string not seen by the user, is stored on a device adapted to couple to a universal serial bus (USB) port interface of a processor. Henceforth the term “token” will be often used as the embedded alphanumeric string not seen by the user.

A flash memory data storage device, such as without limiting, Jump drives, Pocket drives, Pen drives, Thumb drives, having an embedded and encrypted alphanumeric string serial number and a software application, is intended to be plugged into a personal computing device, or PC, having internet connectivity. The USB coupling device may also contain a WPK executable program.

Once plugged in, a splash screen automatically appears on the personal computing device prompting the user to enter a password or log-in information, the second factor of the 2-factor approach, (PIN). The PIN and the embedded serial number are then transmitted as electronic data over the Internet to the verification servers to be authenticated, verified, and validated. When the device has been validated, the action that the user wished to execute, for instance use of a credit card, is authorized.

If the submitted password information and or embedded and encrypted serial number information either does not match, is entered incorrectly, or is otherwise corrupt, compromised, or incorrect, authentication and verification will not be approved and the validation of the desired transaction will be rejected by the servers.

When the authenticated device adapted to couple to the USB port is removed from USB port, the user's account is automatically flagged as being “off-line”, thereby preventing that user's further transactions. The user would be required to initiate a new authentication and verification session before a further transaction, for instance, a payment could be made.

Embodiments of the present invention may include an RFID chip which is embedded into a flash memory data storage device and would operate in a manner similar to point of sale services such as the Mobile/Exxon SpeedPass and Mastercard's PayPass system.

Alternate embodiments of the invention may comprise a UPC barcode printed on the device case which will allow the system to be utilized in point of sale retail operations that accept store branded loyalty cards.

It is to be understood that embodiments of the present invention may comprise programming or software code that may be stored on or automatically generated from one or a multitude of authentication and verification servers, or related internet website locations for the purpose of being accessed and downloaded to a user's flash memory data storage device adapted to use the USB interface, such as without limiting Jump drives, Pocket drives, Pen drives, Thumb drives. Such would then allow the user to utilize the authentication and verification system of the instant embodiments. Such software code may be included for instance in a wpkstart.exe executable file.

It is to be further understood that alternate embodiments of the present invention may allow the flash memory data storage device to be connected to a variety of hand held wireless devices including mobile phones, such as without limiting, Blackberry, Palm Pilot, Smart Phones, PDAs, by means of an adapter connection cable, thereby allowing the user to utilize the authentication and verification system of the instant embodiments from a remote location by means of a wired or wireless internet connection.

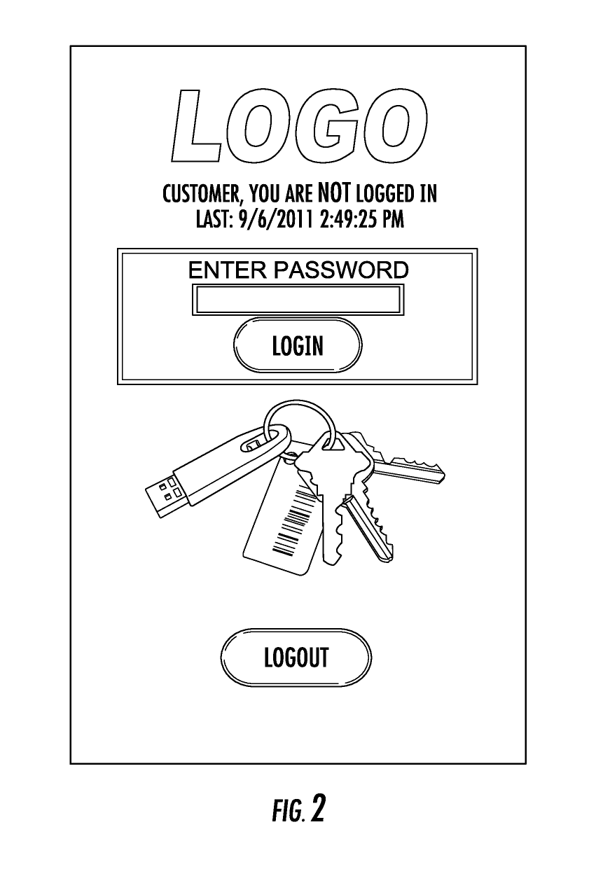

FIG. 2 symbolically shows an embodiment of digital authentication using cell phone provided token. The embodiments involving cell phone provided token are similar in their functions to the embodiments of the USB port utilization, except that they use transmitted signal communication in coupling to the authentication servers.

Embodiment of WPK with mobile application may want to ascertain that the user initiating a transaction is in possession of the mobile device, such as the cell phone. Thus the token involved in the identification may use information regarding the mobile device itself. The cell phone WPK application may acquire the phone's calling number. Alternatively, the cell phone WPK application may acquire the phone's Media Access Control (MAC) address. Alternatively, the cell phone WPK application may acquire the phone's Electronic Serial Number (ESN). Alternatively, the cell phone WPK application may acquire the phone's serial number. It is also possible that the token involves none of the particular mobile device's identifiers, but it is a previously identified general alphanumeric string in similar manner as in the case of USB utilizing devices.

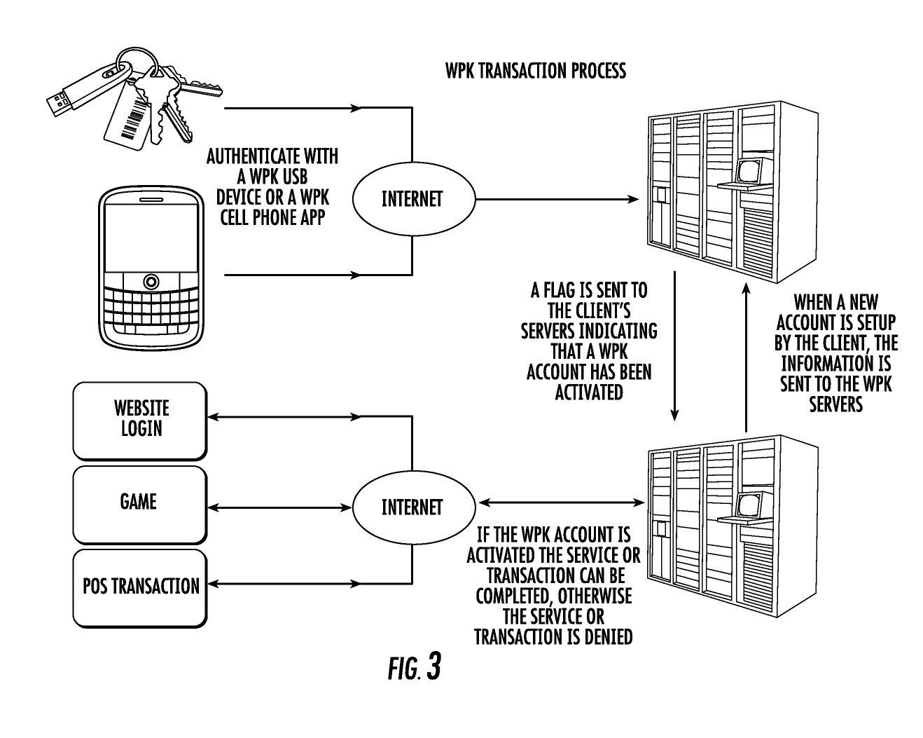

FIG. 3 schematically depicts a top view of a representative embodiment of the present invention. In typical embodiments, whether through use of USB drive or mobile devices, the user submits the PIN attached to that account. The 2-factors, the embedded string and the PIN, are sent over the Internet to the WPK authentication servers. This information is typically sent with Secure Sockets Layer (SSL) and industry standard encryption techniques. Such encryption typically would be hard based for instance, but without limiting, on RSA methods, or on symmetric methods such as Blowfish, or DES.

Once the WPK servers verify the account as valid, the servers will flag that particular WPK account as “Active”. The WPK server then communicates then this information to the client servers. It is understood that the WPK server and client server is a distinction of function only, and may or may not be implemented on differing hardwares.

When a WPK account is attached to a service (credit card, website, game, etc.), that service can not be utilized unless the WPK is flagged as “Active”.

The user may have the option to activate all services the user has attached to the WPK system or the user can activate only one service. For example, if the user has more than one credit card attached to the WPK system, the user can choose a particular credit before enter the PIN. This will activate that one credit card leaving the other cards deactivated.

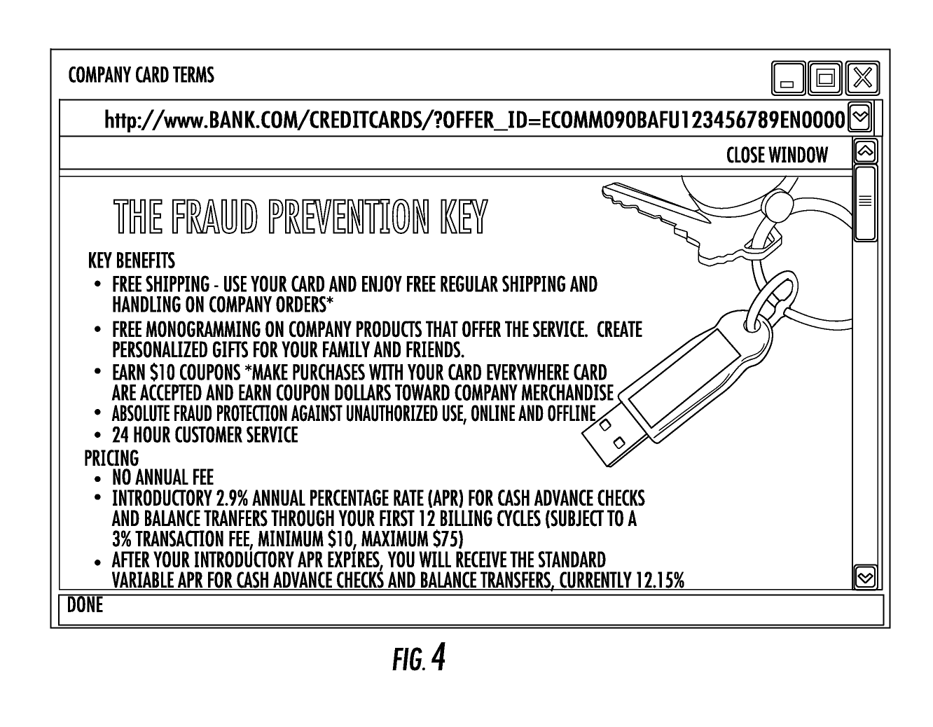

Other options in the WPK applications that are under the control of the user via a web portal, without limitation, may be the ability to add, edit, delete services (credit cards, websites, games, etc.); the ability to automatically deactivate the user's accounts after a fixed time interval; the ability to send an activation notice via SMS and/or e-mail; the ability to send a payment notification via SMS and/or email when a purchase is made with any WPK attached credit card. FIG. 4 symbolically shows use of an embodiment of the present invention over an Internet portal when the user interacts with, for example without limiting, a shopping website (the hypothetical example shows L. L. Bean) equipped for using WPK authentication.

Embodiments of WPK may be used to prevent the un-authorized use of credit/debit cards and other payment systems. Embodiments of WPK may add an extra level of security when logging into websites. Embodiments of WPK may highly restrict users from accessing government, adult, trading websites, etc. Embodiments of WPK may prevent minors from using adult rated games on Xbox, PlayStation, etc. Embodiment of WPK may authenticate access to databases, folders, files, etc. on PC's, LAN's and WAN's. With WPK, safety is maintained even when used on public WiFi systems.

Users have access to their own WPK web portals where they can customize their accounts. Features on each account that can be edited include bank accounts, credit/debit cards, websites, games and other services that are attached to their WPK account. Other features include methods of account activation notification (SMS/Email), time the account is active before it automatically de-activates along with basic contact information.

The WPK web portal may also shows a history of all of the user's WPK activations (date, time, IP address, payment method, items purchased and expenditures). In the social networking, gaming, gambling, adult, personal, video and other web based markets, WorldPassKey will be providing a product line which will ensure their content is being used by the exact customers these companies have in mind.

The software security system of WorldPassKey may be integrated into many vertical markets, in spite of such markets may be vastly different from each other. The WPK software modules may be basically the same for all of the vertical market applications. For instance may be a simple update to bank authentication data base

The WPK software may create instant Card Present (CP) transaction Services. The WPK software may provide downloadable soft token to any personal USB flash drive or Smartphone; may convert existing card not present (CNP) password authentication into strong 2-factor token based security.

The WPK software may allow low cost, rapid conversion of existing online customer access system: simple addition of server side script to server may provide 2nd factor to existing password system. The WPK software may provide additional protection to complement Cryptographic Security. Also, may provide defense against Phishing, Web Spoofing, Key Logging and Chip reading. The WPK software may be Internet downloadable.

Embodiments of WPK may not require any new infrastructure hardware. Embodiments of WPK may be portable from the home and office environment to brick and mortar point of sale (POS) locations.

Embodiments of the present invention reduce the possibilities of Internet purchases being made with stolen or un-authorized credit or debit cards.

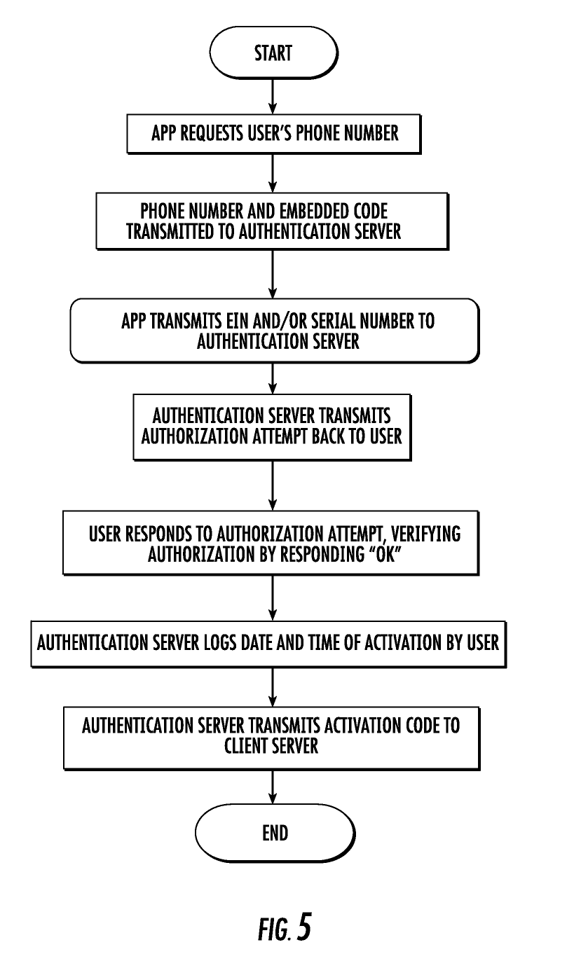

Referring now to FIG. 5, an embodiment of a process for activating an account using WPK is shown. Apps are downloaded from a bank's or other commercial website (client website). The app may have an embedded code that identifies the particular bank or other institution.

After the app is downloaded from the client website and installed on the customer's Smartphone the user may then activate their WPK account. When the app is first clicked on, a screen appears prompting the user to enter their Smartphone number. This number is sent to the WPK authentication server along with the embedded code, if included, related to the client website.

Next, the WPK authentication server sends a text message back to the user's phone number.

When the user receives the text message, the user responds to the message with the phrase “OK” or other pre-defined response. This action verifies to the WPK authentication server that a particular Smartphone attached to a particular client website is ready for use. A date and time stamp is entered in the account on the WPK authentication server for that phone number. This log entry establishes the starting date of activation for that account.

A code is sent to both the WPK authentication server and client server, which flags that particular account as now being active. This code may be the user's phone number, but could be another identification number as well. Depending on the level of security required by the client server, other information can be sent to the WPK authentication server and client server such as the phone's embedded EIN and/or serial number.

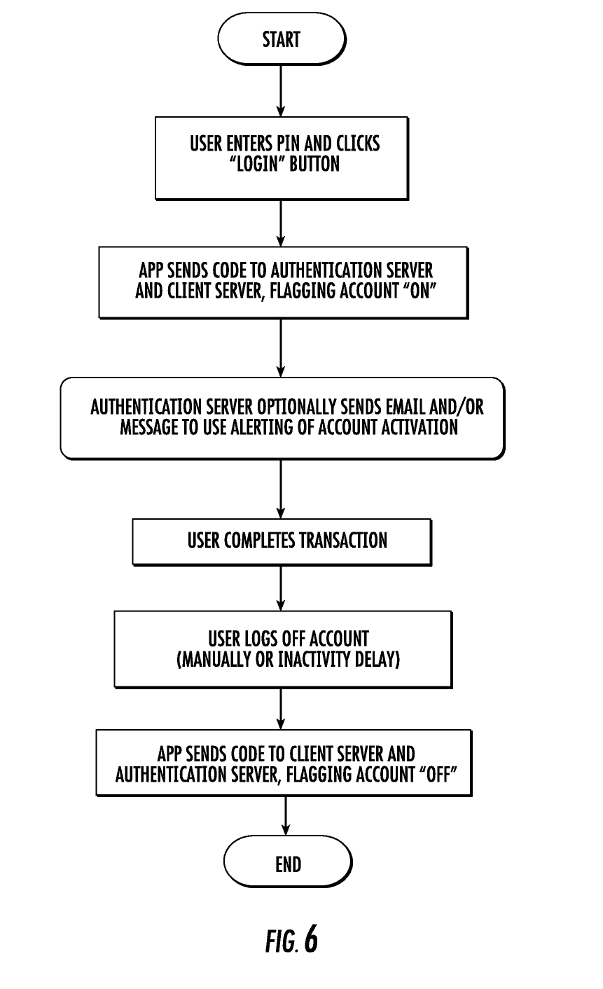

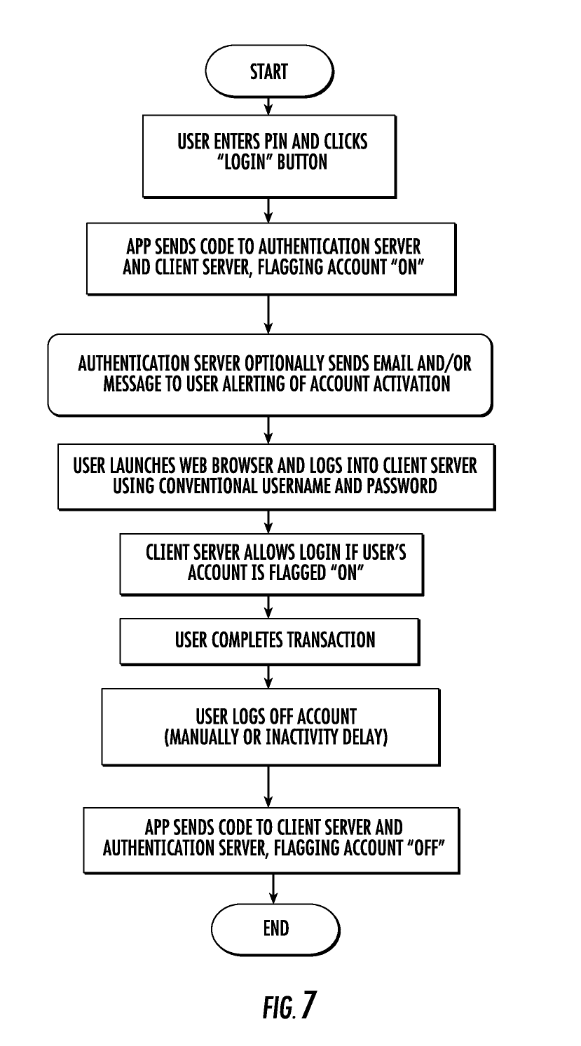

After the user has activated their account, they may use the enhanced 2-factor security in the following manner and as shown in FIGS. 6 and 7. FIG. 6 shows an embodiment where an app is used on a mobile device, such as a smartphone, to access a secured client server. FIG. 7 shows an embodiment where the user uses a web browser to access a secured client server, with authentication being accomplished via a mobile device, such as a smartphone.

Referring to FIG. 6 first, when the app on the user's mobile device is clicked on, the user enters their PIN and clicks the “Login” button. A code is sent to the WPK authentication server and client server, which flags the user's account as being “on”.

When the user logs off their account (manually or by time delay), codes are sent to both the WPK authentication server and client server flagging the account as being “off”. Further attempts to access the client server through the app would be blocked by the client server because the account is flagged as being “off”. The user would then need to re-login to the account.

The user has the option (via a web portal) to setup notification parameters. Whenever the user logs in with their account an email and/or a text message can be sent to them letting them know their account has been turned on.

Referring now to FIG. 7, an embodiment is shown where the user may use a traditional web browser to access a secured client server, where authentication is accomplished, in part, via the user's mobile device. When a WPK app is used to access a secured client server, the user must follow a series of steps to be authenticated. When the app is clicked on, the user enters their PIN and clicks the “Login” button. A code is sent to the WPK authentication server and website hosting the client server which flags the user's account as being “on”.

The user launches a browser directed to the website and enters their conventional username and password credentials. As long as the user's account has been flagged “on” the website can be viewed and transactions completed on the client server.

When the user logs off their account (manually or by time delay), a code is sent to the client server and WPK authentication server flagging the account as being “off”. At this point the use of the user's username and password would not be sufficient to view the website any longer, without first reauthenticating through the WPK app.

The user has the option (via a web portal) to setup notification parameters. Whenever the user logs in with their account an email and/or a text message can be sent to them letting them know their account has been turned on.

The mobile device may be used to control access to a bank card, such as a credit or debit card, but there will be conditions where a mobile device can not be used to authenticate the user's account, and flag the account as “on”. Those conditions could be (but not limited to) out of cell coverage range, dead battery, lost phone, etc.

In those instances, alternatives to authentication through a mobile device application may be accomplished. For instance, the user may call a toll-free number where the user enters their account number and PIN into an automated telephone system, which subsequently sends a code to the WPK authentication server to flag the account as “on”.

Alternatively, the toll-free number may also be used where the user talks to an operator who prompts the user with several questions to verify the user's identity. Once the operator verifies the user's information, the operator activates the user's account.

The user may also access a web portal where the user is prompted with several questions to verify the user's identity. Once the answers are verified, the user's account is activated.

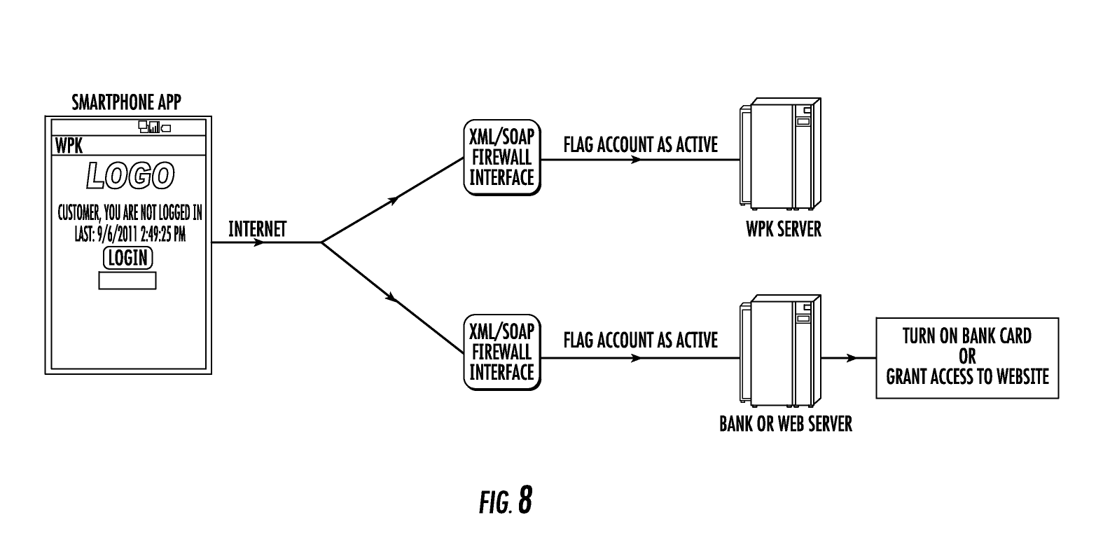

Referring to FIG. 8, The WPK authentication system preferably uses SOAP (Simple Object Access Protocol) to communicate between the user's mobile device over the internet to the WPK authentication server and client server. Using SOAP prevents direct access to either the WPK authentication server or client server, providing an added layer of security.

In the case of banks where user account information is maintained in custom database applications, the WPK authentication system requires the bank to modify a table in the database that contains the bank's client information.

For viewing secured websites, the WPK authentication system requires a WPK software module to be installed on the client server that hosts the website that is to be controlled by WPK.

The module is connected to a database (that resides on the bank's client server or secured website's client server) that contains basic client information.

The client server must include three new fields. The first field is a logical yes/no which is used to let the bank or secured website know that this bank card account or website account, respectively, is ready to accept WPK access control. The second field contains the client's phone number, which may also be used as the WPK user's account number. The third field is a logical yes/no that is used to turn the bank card “on” and “off” for purposes of completing internet-based transactions. Other fields may be added to provide additional layers of security, such as EIN numbers, and serial numbers of specific mobile devices of the user.

The foregoing has outlined, in general, the complete detailed description of the physical process, and or methods of application of the invention and is to serve as an aid to better understanding the intended application and use of the invention disclosed herein. In reference to such, there is to be a clear understanding the present invention is not limited to the method or detail of construction, fabrication, material, or application of use described and illustrated herein. Any other variation of fabrication, use, or application should be considered apparent as an alternative embodiment of the present invention.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature, or element, of any or all the claims.

What is claimed is:

1. A method of authenticating and securing a digital transaction, comprising:
providing a code;
providing a personal identification number;
requesting the personal identification number;
transmitting the personal identification number and code together to an authentication server;
authenticating the code and personal identification number;
flagging a status of a user's account as “on”;
transmitting the status of the user's account to a client server;
allowing a digital transaction to proceed on the client server if the status of the user's account is “on”; and
disallowing a digital transaction to proceed on the client server if the status of the user's account is “off”.

2. The method of claim 1, further comprising flagging the status of the user's account as “off” when the user logs out.

3. The method of claim 2, wherein a code is transmitted to the authentication server and client server, flagging the user's account as “off”.

4. A method of activating a user's account for secured digital transactions, comprising:
providing a code;
requesting a user's phone number;
transmitting the phone number and the code to an authentication server;
transmitting an authorization attempt back to the phone number;
responding to the authorization attempt, confirming the activation of the user's account;
logging the activation of the user's account; and
transmitting an activation code to a client server, confirming activation of the user's account.

5. The method of claim 4, further comprising transmitting a serial number to the authentication server.

6. The method of claim 4, further comprising transmitting an EIN to the authentication server.

7. The method of claim 4, wherein the user responds “ok” to the authorization attempt.

8. The method of claim 4, wherein the authorization attempt is transmitted via text message.

9. The method of claim 4, wherein the code is embedded in a mobile device.

10. The method of claim 4, wherein the code is encoded in an application for a mobile device.

11. The method of claim 4, wherein the communication between the user, the authorization server and the client server is via the Simple Object Access Protocol.

12. A system of authenticating and securing a digital transaction, comprising:
an authentication server having a plurality of user accounts thereon;
a module on a client server having a plurality of user accounts thereon, corresponding to the plurality of user accounts on the authentication server;
each user account having an activation field, a status field and a phone number associated therewith;
an application configured and arranged to run on a mobile device, the mobile device having a phone number and a code thereon, the application configured and arranged to communicate with the client server and the authentication server, the phone number corresponding to a particular user account on the authentication server and the client server;
the authentication server configured and arranged to flag the status field and the activation field on and off via transmissions received and sent to the mobile device, by reference the mobile device phone number and code against a particular user account;
the authentication server further configured and arranged to transmit a change in the state of the status field and activation field to module on the client server; and
The module on the client server configured and arranged to allow and deny transactions based on the state of the status field and activation field.

13. The system of claim 12, wherein the mobile device is a smartphone.

14. The system of claim 12, wherein the application is further configured and arranged to transmit a serial number to the authentication server.

15. The system of claim 12, wherein the application is further configured and arranged to transmit an EIN to the authentication server.

16. The system of claim 12, wherein the application solicits a user response to an authorization attempt to activate a user's account and transmits the user's response to the authentication server.

17. The system of claim 16, wherein the authorization attempt is transmitted via text message.

18. The system of claim 4, wherein the communication between the application, the authentication server and the client server is via the Simple Object Access Protocol.

19. A computer program product, comprising a non-transitory computer-readable medium having a computer-readable program code embodied therein, said computer-readable program code executed to implement a method of authenticating and securing a digital transaction, the method comprising:
providing a code;
providing a personal identification number;
requesting the personal identification number;
transmitting the personal identification number and code together to an authentication server;
authenticating the code and personal identification number;
flagging a status of a user's account as “on”;
transmitting the status of the user's account to a client server;
allowing a digital transaction to proceed on the client server if the status of the user's account is “on”; and
disallowing a digital transaction to proceed on the client server if the status of the user's account is “off”.

20. The method of claim 19, further comprising flagging the status of the user's account as “off” when the user logs out.

21. The method of claim 20, wherein a code is transmitted to the authentication server and client server, flagging the user's account as “off”.

22. A computer program product, comprising a non-transitory computer-readable medium having a computer-readable program code embodied therein, said computer-readable program code executed to implement a method of activating a user's account for secured digital transactions, comprising:
providing a code;
requesting a user's phone number;
transmitting the phone number and the code to an authentication server;
transmitting an authorization attempt back to the phone number;
responding to the authorization attempt, confirming the activation of the user's account;
logging the activation of the user's account; and
transmitting an activation code to a client server, confirming activation of the user's account.

23. The method of claim 22, further comprising transmitting a serial number to the authentication server.

24. The method of claim 22, further comprising transmitting an EIN to the authentication server.

25. The method of claim 22, wherein the user responds “ok” to the authorization attempt.

26. The method of claim 22, wherein the authorization attempt is transmitted via text message.

27. The method of claim 22, wherein the code is embedded in a mobile device.

28. The method of claim 22, wherein the code is encoded in an application for a mobile device.

29. The method of claim 22, wherein the communication between the user, the authorization server and the client server is via the Simple Object Access Protocol.
